(19) United States
(12) Patent Application Publication
(10) Pub. No.: US 2006/0256686 A1
(43) Pub. Date: Nov. 16, 2006

(54) Information recording and reproducing device and information recording and reproducing system

(75) Inventor: Shinnosuke Torii, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/489,680

(22) Filed: Jul. 20, 2006

Related U.S. Application Data
(62) Division of application No. 10/654,130, filed on Sep. 4, 2003.

(30) Foreign Application Priority Data
Sep. 10, 2002 (JP) 2002-264197

(51) Int. Cl. G11B 7/00

(52) U.S. Cl. 369/53.37

(57) ABSTRACT

Provided is an information recording and reproducing device and an information recording and reproducing system, which comprise an external apparatus connection detector for detecting an electrical connection to an external apparatus. In a case where the external apparatus connection detector detects the connection to the external apparatus, ejection of an optical disk is prohibited. In a case where the connection to the external apparatus is not detected, the ejection of the disk is permitted. Accordingly, problems such as destruction of data occurring when the disk is ejected at a printing time can be prevented.

### BACKGROUND OF THE INVENTION

1. Field of the Invention

This invention relates to an information recording and reproducing device for recording information onto an information recording medium such as an optical disk or reproducing recorded information, and an information recording and reproducing system comprised of an information recording and reproducing device and an external apparatus such as a personal computer.

2. Related Background Art

FIG. 7 is a schematic structural diagram showing a conventional disk recording and reproducing device. In FIG. 7, an optical disk recording and reproducing device serves as an example. As shown in the diagram, the optical disk recording and reproducing device comprises: a chassis 1 serving as a structural base; an optical disk 2; a spindle motor 3 for mounting and rotating the-disk 2; an optical pickup 4; a lead screw 5 serving to transport the optical pickup 4 along the radius of the disk 2; a seek motor 6; and a guide shaft 7 for the optical pickup 4. In addition, FIG. 7 shows an ejection lever 8 which engages with an ejector (not shown) that ejects the disk 2 from the optical disk recording and reproducing device, an ejection lock 9 able to engage with the ejection lever 8, and a plunger 10 for translating the ejection lock.

In a case where the ejection lock 9 is inserted into an opening formed in the ejection lever 8, the ejection lever 8 enters a locked stated, and the disk 2 cannot be ejected. On the other hand, when the ejection lock 9 is removed from the opening in ejection lever 8, the ejection lever 8 is unlocked, and the disk 2 can be ejected by sliding the ejection lever 8.

Next, explanation is given regarding operations of the conventional disk recording and reproducing device. First, the disk 2 is chucked onto the spindle motor 3, and is rotated with a laser light being irradiated from the optical pickup 4 to thereby perform recording and reproducing. Note that in order to drive the optical pickup 4, the seek motor 6 (mainly a stepping motor) arranged on the chassis 1 serves as a driving source. A shaft of the seek motor 6 is a single unit formed with the lead screw 5.

Next, a rotational movement of the lead screw 5 is converted into a linear movement by using a rack (not shown) provided to the optical pickup 4. By using the rack, the pickup 4 is moved by a given distance along the radial direction in accordance. with a rotation angle of the lead screw 5 rotated by seek motor 6 which serves as a driving source. For example, when reproducing the information on the disk 2, the spindle motor 3 rotates the disk 2 a given number of times, and the information written on a track of the disk 2 is read by the optical pickup 4. Simultaneously, the optical pickup 4 is transported intermittently by the seek motor 6 along the radial direction of the disk 2 so as to be able to move freely in a following manner from an inner circumference to an external circumference of the disk 2.

Further, to prohibit the ejection of the disk 2 from the optical disk recording and reproducing device, the plunger 10 inserts the ejection lock 9, which serves as a prohibiting means, into the opening formed in the operation lever 8. Further, when the ejection is to be permitted, the plunger 10 withdraws the ejection lock 9 from the operation lever 8. Therefore, when the ejection is permitted, the ejection lever 8 is operated to eject the disk 2 from the ejector, and when the ejection is prohibited, the ejection operation lever 8 is locked., so that the operation to eject the disk 2 cannot be performed.

Next, explanation is given based on a flowchart shown in FIG. 8 illustrating operations of the conventional disk recording and reproducing device. According to a conventional example, the disk recording and reproducing device comprises, in addition to the above-mentioned construction: a power switch (not shown); a recording mode for performing a recording operation to record inputted information onto the disk 2; a reproducing mode for reading out the information recorded on the disk to perform operations such as reproducing, fast-forwarding, rewinding, and pausing; a switch (not shown) serving as a mode switching means for switching between modes; and a mode detector. The mode detector detects each mode by means of a CPU or the like.

In FIG. 8, first, when a user switches the mode, the mode is detected by the mode detector (S801). In the case where the detected mode is the recording mode, the above-mentioned ejection lock 9 is engaged with the ejection lever 8 to prohibit the ejection of the disk (S802). On the other hand, in the case where the detected mode is the reproducing mode, the ejection lock 9 is withdrawn from the ejection lever 8, enabling the ejection of the disk 2 (S803).

As described above, in the conventional example, the control to prohibit the disk ejection is performed depending on the recording/reproducing operation. Therefore, the connection is made to the external apparatus such as the personal computer, and during an editing mode in which the recorded information is transmitted and processed, the recording/reproducing operations are repeated, so that the ejection of the disk is permitted during the reproducing mode. However, if the disk is ejected with the external apparatus being connected and the information being transmitted and processed, it is difficult to save the information. In some instances, the information itself can be destroyed.

Note that, in the present invention, the term “editing” refers to using the external apparatus to perform processing on the recorded information which has been read from the disk to the external apparatus, the processing including such processes as reordering, deleting, adding, and modifying the information. Further, the term “editing operation” refers to recording/reproducing operations performed at least when writing a directory or other management information (hereinafter, referred to as the “management information”), according to the editing results. Further, a mode for performing the edition operation is referred to as the editing mode.

Next, detailed explanation is given regarding specific operations in the above-mentioned editing mode. In the editing mode, first, the management information and data such as an image, audio, and the like (hereinafter, referred to as the “data”), are read from the disk. Next, the editing, which is the processing of the information that was read to the external apparatus, is performed on the external apparatus. Lastly, the management information and the data are written according to the editing results. Note that the reading of the management information and the data in the editing mode is a reproducing operation. The writing of the management information and the data according to the editing results is a recording operation. Further, the writing of the editing results can be fundamentally divided into 2 types, “new writing” and “writing over”.

Now, when the disk is ejected during the sequence of operations in the above-mentioned editing mode, various problems occur. Below, examples are given of the problems foreseen when the disk is ejected in the above-mentioned editing mode.

(1) In the case where the operations sequence in the editing mode is performed just as described above, first, the reproducing operation to read the management information and the data is performed, then the management information and the data are edited on the external apparatus, and then the management information and the data are written according to the editing results. Therefore, the disk recording and reproducing device is generally performing the reproducing operation during the editing that is performed on the external apparatus. Therefore, according to the conventional construction, the disk can be ejected during the editing performed before writing the editing results. However, when the disk is ejected at the above-mentioned timing, it is clearly impossible to reflect the editing results in the information and the data that are recorded on the disk. However, there is a possibility that the edited new data (hereinafter, referred to as the “new data”) will be lost, but there is no fear of the information on the disk being destroyed.

(2) Below, detailed explanation is given regarding problems which occur when the editing results are being written, when the disk is ejected while writing the data, after writing the data, while writing the management information, and after writing the management information, respectively, in a case where the writing of the data and the writing of the management information are performed in a single sequence set. Note that in the present specification, the writing of the editing results is performed by writing the data first, and then writing the management information.

First, in the case of “new writing”, when the disk is ejected while writing the data and after writing the data, the new data is lost. However, since the integrity of the information that is recorded on the disk is preserved the disk is not destroyed. In other words, according to the management information, the portion of the disk where the new data was written becomes an empty area where no information is recorded. Therefore, while reproduction of this data is impossible, new data can be written onto that portion.

Further, when the disk is ejected while writing the management information, the integrity within the recorded information cannot be maintained, and thus the information on the disk is destroyed. In particular, in this case, since the management information is destroyed, not only is a portion of the information in the disk destroyed, but there is also a great possibility that the information on the entire disk may be destroyed. Of course, the new data is lost. If the disk is ejected after recording the management information, the damage caused by ejecting the disk does not occur.

Next, in the case of “writing overt”, if the disk is ejected while writing and after writing, the new data and the old data will be lost, and the integrity with the management information cannot be maintained. Therefore, when a user tries to access the corresponding information, the data may be inaccessible or other problems may occur. However, there is little possibility that the entire disk is destroyed. Further, when the disk is ejected while writing the management information, the integrity within the recorded information cannot be maintained, similarly to the case when performing the “new writing”, and the information on the disk is destroyed. Of course, the new data and the old data are lost. If the disk were ejected after recording the management information, the problems caused by the disk ejection would not occur.

(3) Detailed explanation is given regarding a case where the management information is written all at once, in a case where, during the editing mode, the management information is read, then the data is read, the editing is performed, the edited data is written, and then other data is read, and edited and written, and all the editing has ended. In such a case, since the reproducing operations and the recording operations are repeated in the editing mode, in accordance with the conventional construction, the disk can be ejected during the reproducing operations.

However, when the disk is ejected before writing the management information, in the case of “new writing”, the new data is lost, which is similar to the case described in item (2), and thus the integrity cannot be maintained. Further, when “writing over”, the new data and the old data are lost, and in addition, the integrity cannot be maintained. Further, in the case where the ejection is performed while writing the management information, similarly to the case described in item (2), the integrity within the recorded information cannot be maintained, and the information in the disk is destroyed. If the disk were ejected after recording the management information, the problems caused by ejecting the disk would not occur.

As described in detail above, ejecting the disk during the editing mode causes various problems ranging from the loss of the data to the destruction of the entire disk due to the destruction of the management information.

Further, the present invention is effective not only for preventing the problems occurring during editing, but also, for example, in an external apparatus arranged with a printing means such as a printer. That is, in the case where the connection is made to the external apparatus and the information recorded on the disk is printed by the printing means such as the printer, at the printing time, in order to read out the information, the disk recording and reproducing device switches to the reproducing mode. Therefore, in accordance with the conventional disk recording and reproducing device, the disk can be ejected, because of the reasons mentioned above.

However, when the disk is ejected during the above-mentioned operations, it is evident that problems will occur. Further, loss occurs in terms of consumable articles such as printer paper, ink, and toner which are used in printing. Note that the “external apparatus arranged with the printing means” refers to, for example, a personal computer connected to a printer, or an external apparatus having a so-called “direct printing” function, or the like.

Note that in the present invention, the above-mentioned editing mode and the mode for connecting and printing from the external apparatus arranged with the printing means are collectively referred to as an external apparatus mode.

Further, there are some techniques in which ejection is always prohibited regardless of recording/reproducing, and the ejection is permitted only when the power is off. However, according to these techniques, the ejection is prohibited even during simple reproducing operations. Therefore, the disk cannot be exchanged when necessary, giving the user an unpleasant sense of operation.

### SUMMARY OF THE INVENTION

The present invention provides an information recording and reproducing device and an information recording and reproducing system, in which ejection of a recording medium is prohibited during a connection to an external apparatus, to thereby prevent destruction of data occurring when the recording medium is ejected. Note that the present invention is not restricted only to an editing mode operation sequence that is given as an example above.

According to the present invention, there is provided an information recording and reproducing device, which is electrically connectable to an external apparatus and has at least one of a function of recording information from the external apparatus onto an information recording medium and a function of sending information read from the recording medium to the external apparatus, the information recording and reproducing device comprising:

a connection detecting means for detecting a connection to the external apparatus; and

a prohibiting means for prohibiting ejection of the recording medium in accordance with a detection result from the connection detecting means.

### BRIEF DESCRIPTION OF THE DRAWINGS

FIG. 1 is a block diagram showing a construction of Embodiment 1 according to the present invention;

FIG. 2 is a flowchart showing operations of Embodiment 1;

FIG. 3 is a block diagram showing a construction of Embodiment 2 according to the present invention;

FIG. 4 is a flowchart showing operations of Embodiment 2;

FIG. 5 is a block diagram showing a construction of Embodiment 3 according to the present invention;

FIG. 6 is a flowchart showing operations of Embodiment 3;

FIG. 7 is a diagram showing a construction of a conventional example of a disk recording and reproducing device; and

FIG. 8 is a flowchart showing operations of the conventional device shown in FIG. 7.

### DESCRIPTION OF THE PREFERRED EMBODIMENTS

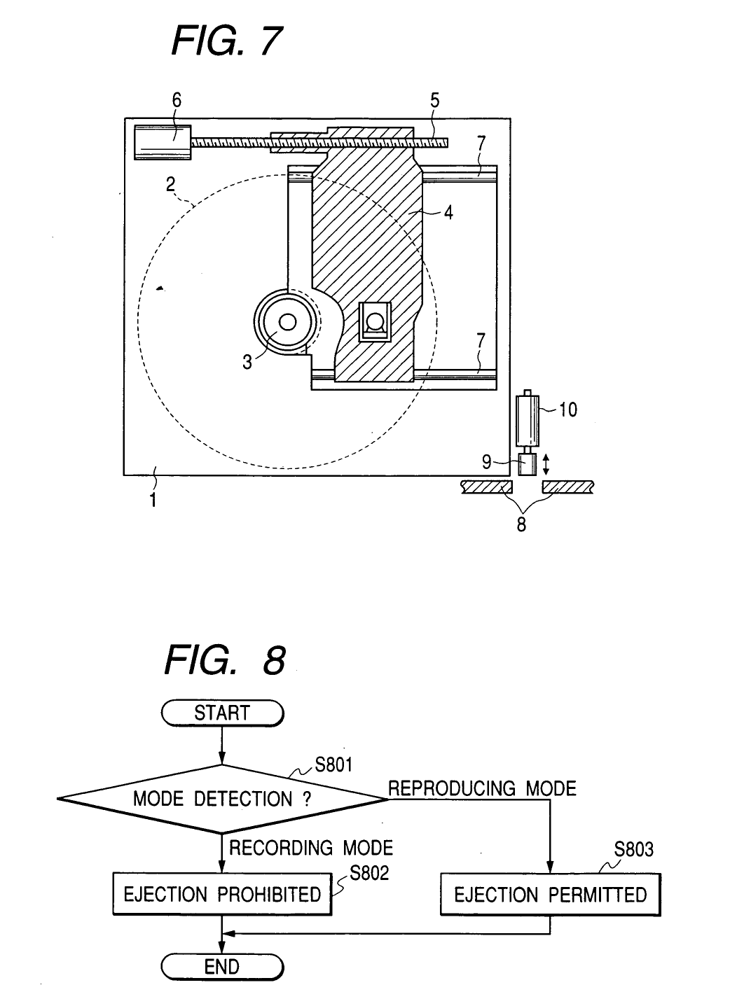

Next, embodiments of the present invention are explained in detail, with reference to the drawings. Basic constructions of an information recording and reproducing device according to the present invention are similar to those of a conventional device shown in FIG. 7.

### Embodiment 1

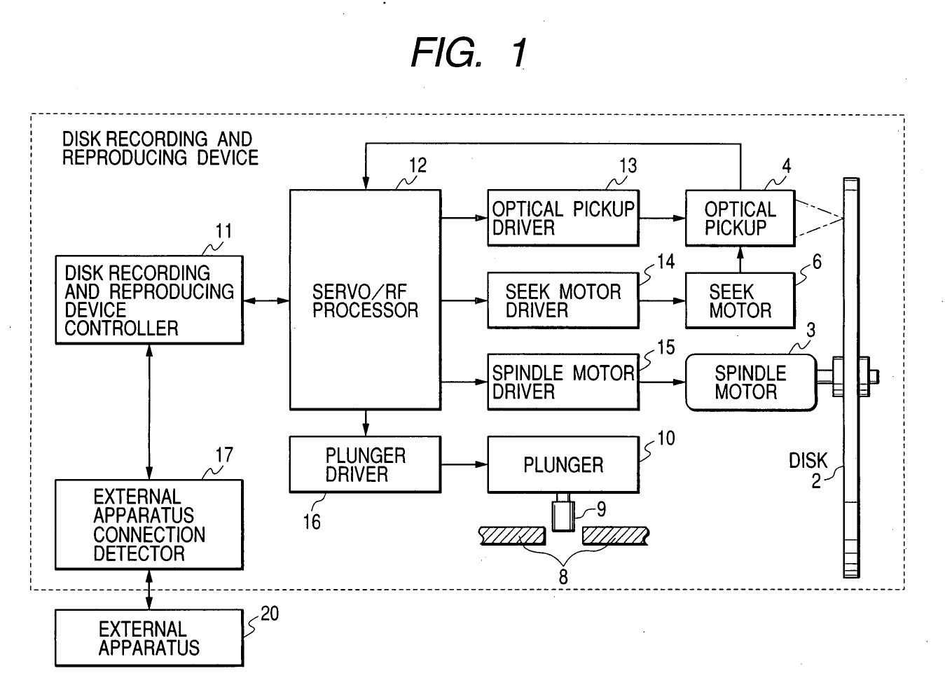

FIG. 1 is a block diagram depicting Embodiment 1 of the present invention. Note that in FIG. 1, the same reference numerals are used to reference the same components as in FIG. 7, and their explanations are omitted. In FIG. 1, a disk recording and reproducing device controller (hereinafter, referred to as the “controller”) 11 includes a CPU, a memory and the like. The controller 11 integrally controls the overall device, principally performing each sequence control. The controller 11 communicates with an external apparatus 20, and stores data from the external apparatus 20 onto a disk 2, or sends data that is read from the disk 2 to the external apparatus 20. The external apparatus 20 may be, for example, a personal computer for performing editing processes as described above, or printing the data from the disk 2 by using a printer.

A servo/RF processor 12 controls an optical pickup driver 13, a seek-motor driver 14, a spindle motor driver 15, and a plunger driver 16. When performing the control, the servo/RF processor 12 processes an output signal from an optical sensor (not shown) detecting light reflecting from the disk 2 into an optical pickup 4, and controls the optical pickup 4, the spindle motor 3, and the seek motor 6, based on a servo signal.

An external apparatus connection detector 17 detects an electric connection between the disk recording and reproducing device and the external apparatus (such as a personal computer) 20. In this embodiment, for example, the disk recording and reproducing device and the external apparatus 20 are connected using a Universal Serial Bus (USB) port. The USB has a switch (not shown) at the port, and the external apparatus connection detector 17 monitors the USB port switch, to detect the connection with the external apparatus 20. Note that the basic constructions and operations of the disk recording and reproducing device and the external apparatus are similar to those of the conventional device, and explanations are therefore omitted.

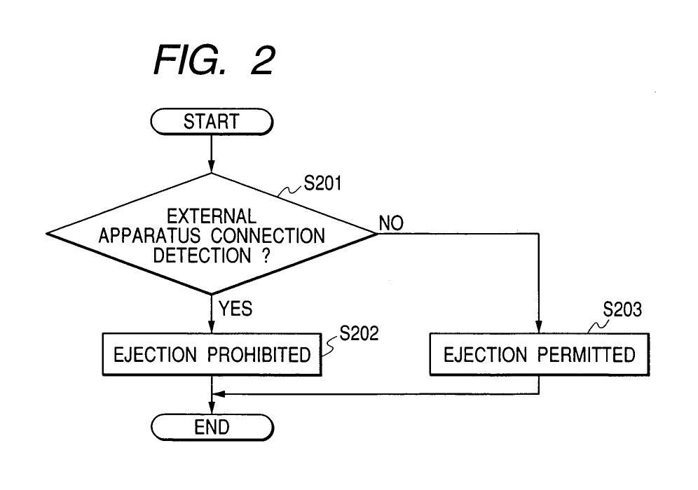

Next, operations of this embodiment are explained, with reference to the flowchart shown in FIG. 2. In FIG. 2, first, when the external apparatus 20 such as a personal computer is connected to the USB port of the disk recording and reproducing device, the external apparatus connection detector 17 detects the connection with the external apparatus 20 (S201). When the detection is made, the controller 11 controls the plunger driver 16 via the servo/RF processor 12. By driving a plunger 10, an ejection lock 9 serving as an ejection prohibiting means is inserted (S202) into an opening formed in an ejection lever 8. By inserting the lock 9 into the opening, the ejection lever 8 is locked, with the result that the ejection of the disk 2 is prohibited. On the other hand, in a case where the external apparatus connection detector 17 does not detect the connection with the external apparatus 20, the ejection lock 9 is withdrawn from the opening in the ejection lever 8, so the disk 2 can be ejected by operating the ejection lever 8 (S203).

In this embodiment, when the connection with the external apparatus 20 is detected, the ejection of the disk is prohibited, thus preventing ejection of the disk due to an erroneous operation, for example, when connected to the external apparatus and sending and processing information. Therefore, problems due to the ejection of the disk mentioned above can be avoided, which include: erasure of the new and old data; destruction of the integrity with the management information; destruction of the information in the disk due to destruction of the management information; and destruction of the information on the entire disk. Even in a case where the external apparatus such as a personal computer has a printing means such as a printer, the above-mentioned problems occurring at a printing time can be avoided as well.

### Embodiment 2

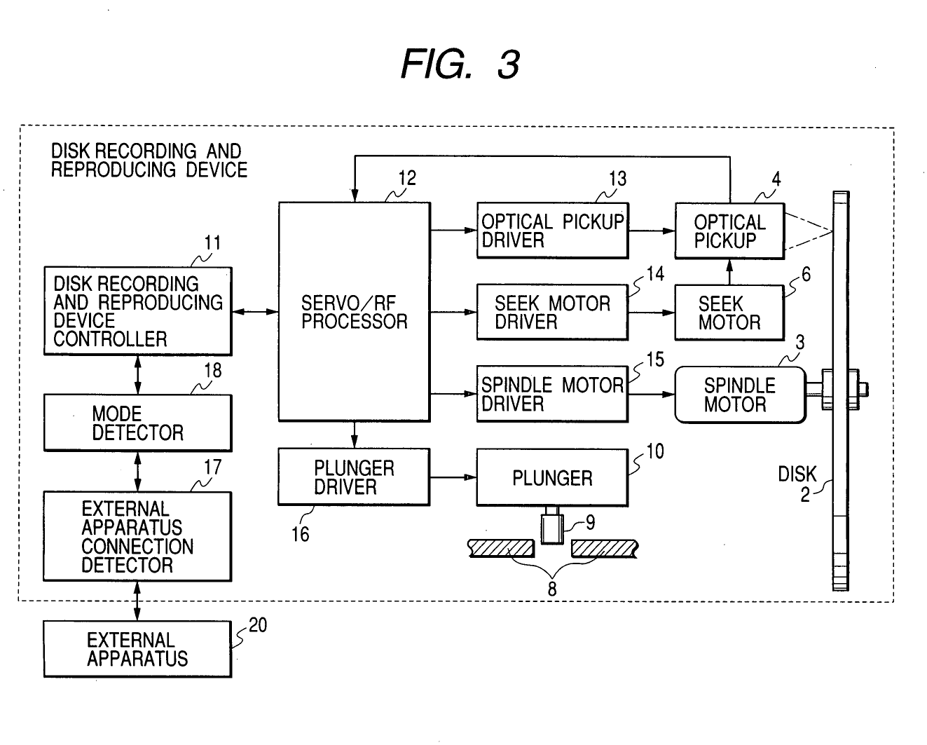

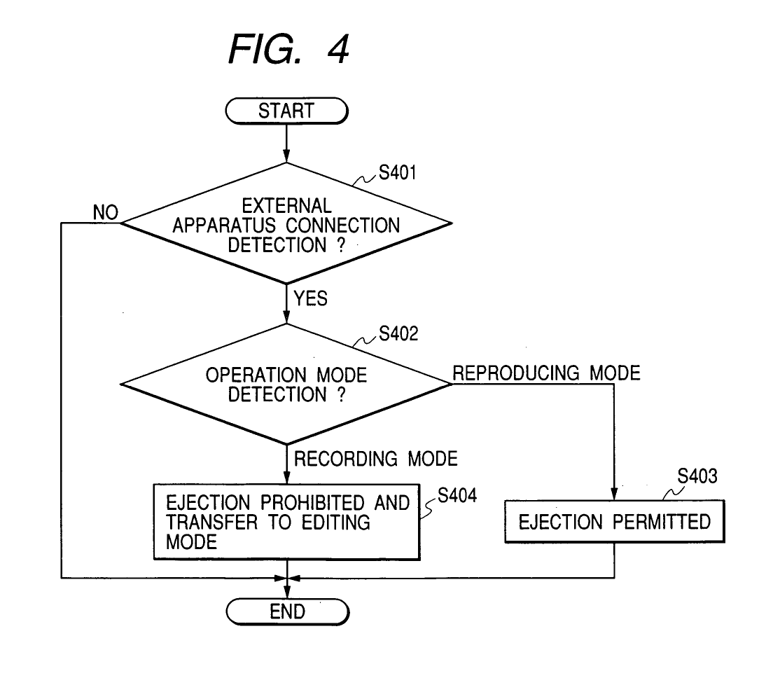

FIG. 3 is a block diagram showing Embodiment 2 of the present invention. In contrast to Embodiment 1, a mode detector 18 for detecting an operation mode is provided between the controller 11 and the external apparatus connection detector 17. FIG. 4 is a flowchart showing operations of this embodiment.

This embodiment includes: two operation modes, that is, a reproducing mode for reading out the information recorded-on the disk 2 to perform operations such as reproducing, fast-forwarding, rewinding, and pausing, and a recording mode for recording inputted information onto the disk 2; a switching means for switching between the modes; and the mode detector 18 for detecting the mode. The mode detector 18 detects the mode by means of the CPU or the like.

Next, the operations are explained with reference to FIG. 4. First, when the external apparatus connection detector 17 detects the connection to the external apparatus 20 (S401), the mode detector 18 then detects the modes (S402). In a case where the detected mode is the reproducing mode, the controller 11 controls the plunger driver 16 via the servo/RF processor 12. Then, the plunger 10 is driven to withdraw the ejection lock 9 from the opening formed in the ejection lever 8. Therefore, the disk 2 can be ejected by operating the ejection lever 8 (S403).

On the other hand, in a case where the detected mode is the recording mode, the mode switches not to the recording mode, but rather to the above-mentioned external apparatus mode (the mode combining the editing mode and the mode for printing). In other words, the disk recording and reproducing device sends a signal for editing or printing to the external apparatus 20, to enable an editing procedure or a printing procedure. The controller 11 controls the plunger driver 16 via the servo/RF processor 12. Thus, the plunger 10 is driven to insert the ejection lock 9 serving as the ejection prohibiting means into the opening in the ejection lever 8. Since those operations lock the operation lever 8, the disk 2 cannot be ejected (S404).

In this embodiment, when the connection to the external apparatus 20 is detected and the reproducing mode is detected, the disk can be ejected, which facilitates exchanging the disk and gives a user a pleasurable sense of operation. When the connection to the external apparatus 20 is detected and the recording mode is detected, the mode is switched to the external apparatus mode, and the ejection of the disk is prohibited. Therefore, it is possible to prevent the disk ejection caused by the erroneous operation, or the like upon connecting the disk recording and reproducing device with the external apparatus and transmitting and processing the information. Furthermore, the problems due to the ejection of the disk mentioned above can be avoided, which include: erasure of the new and old data; destruction of the integrity with the management information; destruction of the information in the disk due to destruction of the management information; and destruction of the information on the entire disk.

Even in the case where the external apparatus such as a personal computer includes the printing means such as a printer, the above-mentioned problems occurring at the printing time can be avoided. Additionally, in this embodiment, for example, when a switch is used as the switching means for switching the mode, the number of modes is reduced to two modes, that is, the reproducing mode, and the external apparatus mode. Therefore, the number of switching portions or contact points can be reduced, as compared to the case where the switching portions or contact points are needed to handle the three modes mentioned above.

### Embodiment 3

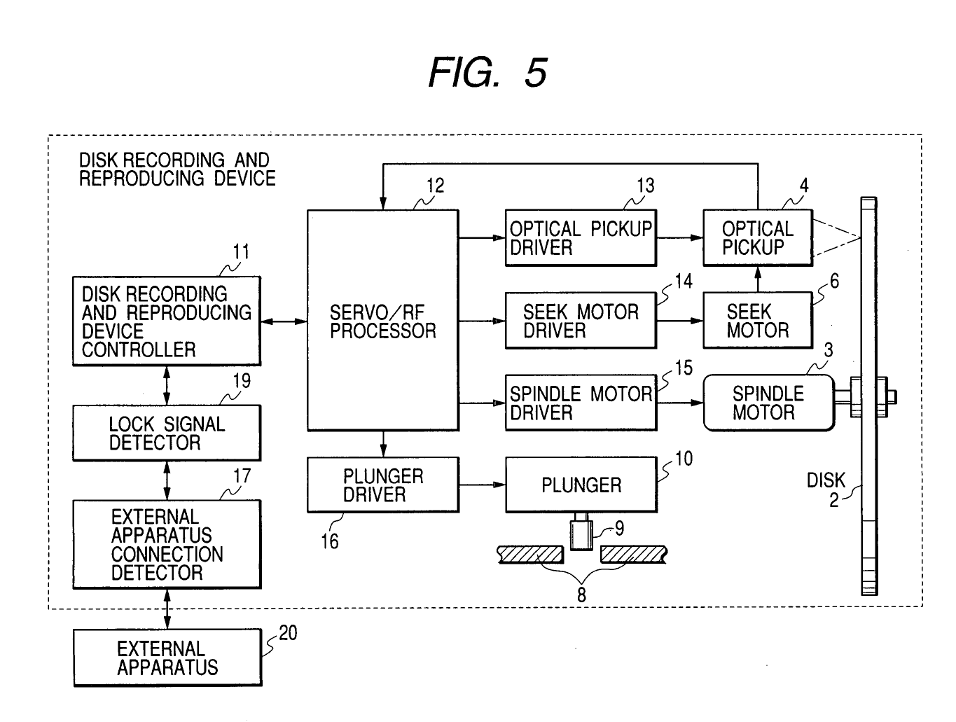

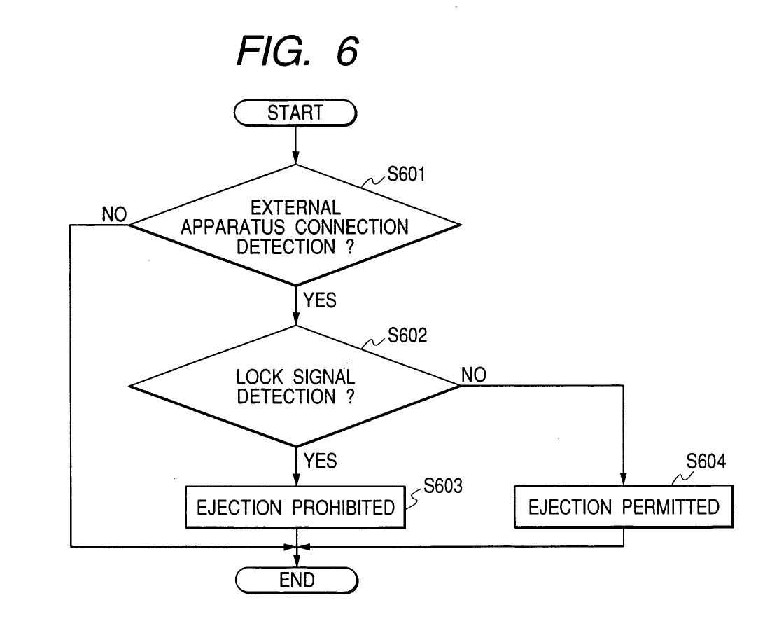

FIG. 5 is a block diagram showing Embodiment 3 of the present invention. In contrast to Embodiment 1, a lock signal detector 19 is provided between the controller 11 and the external apparatus connection detector 17. FIG. 6 is a flowchart showing operations of this embodiment.

In this embodiment, for example, the external apparatus 20 such as a personal computer has an editing means for performing editing procedures of the recorded information, and a transmitting means for transmitting a lock signal. At a time when the external apparatus is connected to the disk recording and reproducing device to perform the editing procedure, the lock signal is sent out when writing management information such as directory information. A lock signal detector 19 in the disk recording and reproducing device detects the lock signal.

In this embodiment, the USB is used as an example to explain the connecting means to the external apparatus 20. In the connecting means such as the USB to the external apparatus 20, the external apparatus 20 and the disk recording and reproducing device act as a host and a device, respectively. Control to determine whether an object being currently recorded/reproduced is the management information or the data is performed on the host side only. On the device side, it is possible to learn whether recording or reproducing is being performed, but it is not possible to learn whether the object being recorded/reproduced is the management information or the data.

Therefore, it is necessary to generate a lock signal on the host side, and to detect the lock signal on the device side. The USB has a “Device Class” protocol, and a “Mass Storage” device class is generally used with disk recording and reproducing devices. When using the “Mass Storage” protocol, the external apparatus such as a personal computer serves as the host, and the disk recording and reproducing device serves as the device. Therefore, when disk ejection is prohibited, a lock signal from the external apparatus is transmitted, and in response to this lock signal, the disk ejection from the disk recording and reproducing device is prohibited. Note that when using the USB “Mass Storage” protocol, the lock signal can be achieved by means of a “PREVENTAL/ALLOW MEDIUM REMOVAL” command.

That is, as shown in FIG. 6, the external apparatus 20 such as a personal computer is connected at the USB port or the like. When the external apparatus connection detector 17 detects the connection to the external apparatus (S601), the lock signal detector 19 detects the lock signal (S602). When the lock signal is detected, the controller 11 drives the plunger 10 via the servo/RF processor 12 to insert the ejection lock 9 as the ejection prohibiting means into the opening in the ejection lever 8, with the result that the ejection of the disk is prohibited (S603). Further, in the case where the lock signal detector 19 detects no lock signal, the ejection lock 9 is withdrawn from the ejection lever 8 to enable the ejection of the disk (S604).

By inserting and withdrawing the ejection lock 9, it becomes possible to prevent problems involved in disk ejection as described above, which include: the destruction of the information on the disk due to destruction of the management information; and destruction of the information on the entire disk. Therefore, not only in the reproducing mode but also in the editing mode, the destruction of the disk is prevented, while facilitating exchange of the disk in other situations. Therefore, a positive sense of operation is given to the user. Note that in this embodiment, the USB was used as the connecting means to the external apparatus. However, the present invention is not limited to this construction. For example, an ATAPI or the like may be used as well.

### Embodiment 4

Next, explanation is given regarding Embodiment 4 of the present invention. Constructions of Embodiment 4 are similar to those of Embodiment 3 shown in FIG. 5. Operations of this embodiment are also similar to the flowchart shown in FIG. 6. In this embodiment, the lock signal is sent out when the external apparatus 20 is connected to the disk recording and reproducing device and the editing procedures are being performed, specifically while writing and after writing the data (such as an image or audio), and when writing the management information such as directory information. The lock signal is then detected by the lock signal detector 19, which is provided to the disk recording and reproducing device.

Here, as shown in FIG. 6, the external apparatus 20 such as a personal computer is connected at the USB port or the like, and the external apparatus connection detector 17 detects the connection to the external apparatus 20 (S601). When the lock signal detector 19 detects the lock signal (S602), the controller 11 drives the plunger 10 to insert the ejection lock 9 serving as the ejection prohibiting means into the opening in the ejection lever 8, with the result that the ejection of the disk 2 is prohibited (S603). On the other hand, in the case where the lock signal detector 19 detects no lock signal, the ejection lock 9 is withdrawn from the ejection lever 8 to enable the ejection of the disk 2 (S604).

By inserting and withdrawing the ejection lock 9, it becomes possible to prevent problems involved in disk ejection as described above, which include: the destruction of integrity with the management information; the destruction of the information on the disk due to destruction of the management information; and destruction of the information on the entire disk. Therefore, not only in the reproducing mode but also in the editing mode, the integrity with the management information is maintained, thus preventing the destruction of the disk, while facilitating exchange of the disk in other situations. Therefore, a positive sense of operation is given to the user. However, use of the construction (3) mentioned above merely prevents the destruction of the entire disk. Note that in this embodiment, the USB was used as the connecting means to the external apparatus. However, the present invention is not limited to this construction. For example, an ATAPI or the like may be used as well.

### Embodiment 5

Next, explanation is given regarding Embodiment 5 of the present invention. Constructions of Embodiment 5 are similar to those of Embodiment 3 shown in FIG. 5. Operations of this embodiment are also similar to the flowchart shown in FIG. 6. In this embodiment, a printing means is provided in the external apparatus 20. The lock signal is sent out when the external apparatus 20 is connected to the disk recording and reproducing device and the information recorded in the disk 2 is transmitted and printed. Then, the lock signal detector 19, which is provided to the disk recording and reproducing device, detects the lock signal from the external apparatus 20.

Here, as shown in FIG. 6, the external apparatus 20 such as a personal computer is connected at the USB port or the like, and the external apparatus connection detector 17 detects the connection to the external apparatus 20 (S601). When the lock signal detector 19 detects the lock signal (S602), the controller 11 drives the plunger 10 via the servo/RF processor 12 to insert the ejection lock 9 serving as the ejection prohibiting means into the opening in the ejection lever 8, with the result that the ejection of the disk 2 is prohibited (S603). On the other hand, in the case where the lock signal is not detected, the ejection lock 9 is withdrawn from the ejection lever 8 to enable the ejection of the disk 2 (S604).

In this embodiment, when the connection with the external apparatus 20 is detected, the ejection of the disk is prohibited. Thus, it becomes possible to avoid the above-mentioned problems involved in disk ejection occurring at the printing time. Note that in this embodiment, the USB was used as the connecting means to the external apparatus, but the connecting means is not restricted to the USB. For example, the ATAPI or the like may be used.

As described above, the present invention has the following effects.

(a) When the disk recording and reproducing device is connected to the external apparatus for transmitting and processing the information, the ejection of the recording medium from the information recording and reproducing device is prohibited, enabling prevention of the destruction of the information which occurs when the disk is ejected, and the problems occurring at the printing time.

(b) After connecting the device to the external apparatus and switching the operation mode to the reproducing mode, the recording medium can be ejected. In contrast, after connecting the device to the external apparatus and switching the operation mode to the recording mode, the operation mode is switched to the external apparatus mode and the ejection of the recording medium is prohibited, to facilitate exchange of the medium in the reproducing mode, and giving the user a pleasurable sense of operation. Further, even in the case where the external apparatus such as a personal computer has the printing means such as a printer, the above-mentioned problems occurring at the printing time can be avoided.

(c) The external apparatus has an editing means for performing editing procedures of the recorded information, and a transmitting means for transmitting a lock signal. At a time when performing the editing procedure, the lock signal is sent out when writing management information such as directory information and the ejection of the medium is prohibited in response to the lock signal. Thus, it becomes possible to prevent problems involved in medium ejection, which include: the destruction of the information on the medium due to destruction of the management information; and destruction of the information on the entire medium. Therefore, not only in the reproducing mode but also in the editing mode, the destruction of the medium is prevented, while facilitating exchange of the medium in other situations. Therefore, a positive sense of operation can be given to the user.

(d) The lock signal is sent out when, in the external apparatus, the editing procedures are being performed, specifically while writing and after writing the data (such as an image or audio), and when writing the management information such as directory information. The ejection of the medium is prohibited in response to the lock signal. Thus, it becomes possible to prevent problems involved in medium ejection, which include: the destruction of integrity with the management information; the destruction of the information on the medium due to destruction of the management information; and destruction of the information on the entire medium. Therefore, not only in the reproducing mode but also in the editing mode, the integrity with the management information is maintained, thus preventing the destruction of the disk, while facilitating exchange of the medium in other situations. Therefore, a positive sense of operation can be given to the user.

(e) When transmitting and printing the information recorded on the medium, the lock signal is transmitted from the external apparatus arranged with the printing means. In response to this lock signal, the ejection of the medium is prohibited, to avoid the problems involved in the medium ejection occurring at the printing time.

1. An information recording and reproducing device, which is electrically connectable to an external apparatus and has at least one of a function of recording information from the external apparatus onto an information recording medium and a function of sending information read from the recording medium to the external apparatus, the information recording and reproducing device comprising:
a connection detecting means for detecting a connection to the external apparatus; and
a prohibiting means for prohibiting ejection of the recording medium in accordance with a detection result from the detecting means.

2. The information recording and reproducing device according to claim 1, further comprising:
means for switching a mode between a reproducing mode and a recording mode; and
a mode detecting means for detecting the mode, wherein:
in a case where the connection detecting means detects the connection to the external apparatus and the mode detecting means detects the reproducing mode, the ejection of the recording medium is permitted; and
in a case where the connection detecting means detects the connection to the external apparatus and the mode detecting means detects the recording mode, the ejection of the recording medium is prohibited.

3. The information recording and reproducing device according to claim 1, wherein:
the external apparatus comprises:
an editing means for performing an editing operation on the information; and
a lock signal transmitting means for transmitting a lock signal when writing management information such as directory information during the editing operation; and
in a case where the connection detecting means detects the connection to the external apparatus and a lock signal detecting means detects the lock signal, the ejection of the recording means is prohibited.

4. The information recording and reproducing device according to claim 3, wherein the lock signal transmitting means further transmits the lock signal while writing data and after writing the data, during the editing operation.

5. (canceled)

6. An information recording and reproducing system comprising the information recording and reproducing device according to claim 1 and an external apparatus.

7. The information recording and reproducing device according to claim 1, wherein the connection is a USB connection.

8. The information recording and reproducing device according to claim 1, wherein the connection is an ATAPI connection.
